(19) United States
(12) Patent Application Publication
(10) Pub. No.: US 2010/0315810 A1
(43) Pub. Date: Dec. 16, 2010

(54) LED lighting device with illumination angle adjustment mechanism

(76) Inventor: Shih-Tsung Tseng, Taipei (TW)

Correspondence Address: SAM CHEN, 7F-1, 293, ROOSEVELT ROAD, SEC 3, TAIPEI, TW

(21) Appl. No.: 12/481,615

(22) Filed: Jun. 10, 2009

(51) Int. Cl. F21V 15/01

(52) U.S. Cl. 362/234

(57) ABSTRACT

An LED lighting device in one embodiment includes a housing having two inclined open sides and two end segments having two arcuate side slots proximate a top; a controller in the housing; a first light source affixed to a bottom of the housing and comprising a plurality of first LED members electrically connected to the controller; and two second light sources comprising a plurality of second LED members electrically connected to the controller, two pivots each pivotably secured to a bottom corner of either end segment of the housing, and two sliding members each slidably disposed in the slot. Both sides of the housing are concealed by the second light sources. Either second light source may pivot about the pivots to adjust an angle of illumination of the second LED members by moving the sliding members along the slots.

### BACKGROUND OF THE INVENTION

1. Field of Invention

The invention relates to LED (light-emitting diode) lighting devices and more particularly to such an LED lighting device having an illumination angle adjustment mechanism with improved characteristics.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

However, LED lighting devices have drawbacks including strong directivity (being a point light source) and glaring quality. A conventional LED lighting device comprises a plurality of LED members arranged together as a light source which is directed to a desired point of illumination. Further, an adjustable louver is provided on a transparent globe of the LED lighting device so that a person may manipulate the louver to adjust an angle of illuminated light. However, it still has a drawback of one illumination angle for one specific place being not suitable for another specific place. In detail, an LED lighting device having a wide angle of illumination is not suitable to be a light source when it is installed in a place with higher elevation. This is because the desired brightness of illumination cannot be obtained. To the contrary, an LED lighting device having a narrow angle of illumination is not suitable to be a light source when it is installed in a place with lower elevation. This is because the desired range of illumination cannot be obtained. Thus, it is desirable to provide a novel LED lighting device with an illumination angle adjustment mechanism in order to overcome the inadequacies of the prior art.

There have been numerous suggestions in prior patents for LED lighting device. For example, U.S. Pat. No. 6,942,361 discloses a light source for white color LED lighting and white color LED lighting device.

### SUMMARY OF THE INVENTION

It is therefore one object of the invention to provide an LED lighting device having an illumination angle adjustment mechanism.

In one aspect of the invention there is provided an LED lighting device comprising a glass housing having two inclined open sides and two end segments having two arcuate side slots proximate a top; a controller mounted in the housing; a first light source affixed to a bottom of the housing and comprising a plurality of first LED members mounted thereon, the first LED members being electrically connected to the controller; and two second light sources comprising a plurality of second LED members mounted thereon, the second LED members being electrically connected to the controller, two pivots each pivotably secured to a bottom corner of either end segment of the housing, and two sliding members each slidably disposed in the slot. Both the inclined open sides of the housing are concealed by the second light sources. Either second light source may pivot about the pivots to adjust an angle of illumination of the second LED members by moving the sliding members along the slots.

In another aspect of the invention there is provided an LED lighting device comprising a housing having two inclined open sides and two end segments having two arcuate side slots proximate a top; a controller mounted in the housing; and two light sources comprising a plurality of LED members mounted thereon, the second LED members being electrically connected to the controller, two pivots each pivotably secured to a bottom corner of either end segment of the housing, and two sliding members each slidably disposed in the slot, wherein both the inclined open sides of the housing are concealed by the light sources, and either second light source is adapted to pivot about the pivots to adjust an angle of illumination of the LED members by moving the sliding members along the slots.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of LED lighting device according to the invention;

FIG. 2 is an exploded view of the LED lighting device;

FIG. 3 is an end view of the LED lighting device;

FIG. 4 is a sectional view taken along line 4-4 of FIG. 3;

FIG. 5 is a sectional view taken along line 5-5 of FIG. 1;

FIG. 6 is a view similar to FIG. 3 in part section showing the pivotal light sources being pivotal about the first projecting members; and

FIGS. 7, 8, and 9 are views similar to FIG. 6 showing three different angles of illumination by pivoting the pivotal light sources about the first projecting members respectively.

### DETAILED DESCRIPTION OF THE INVENTION

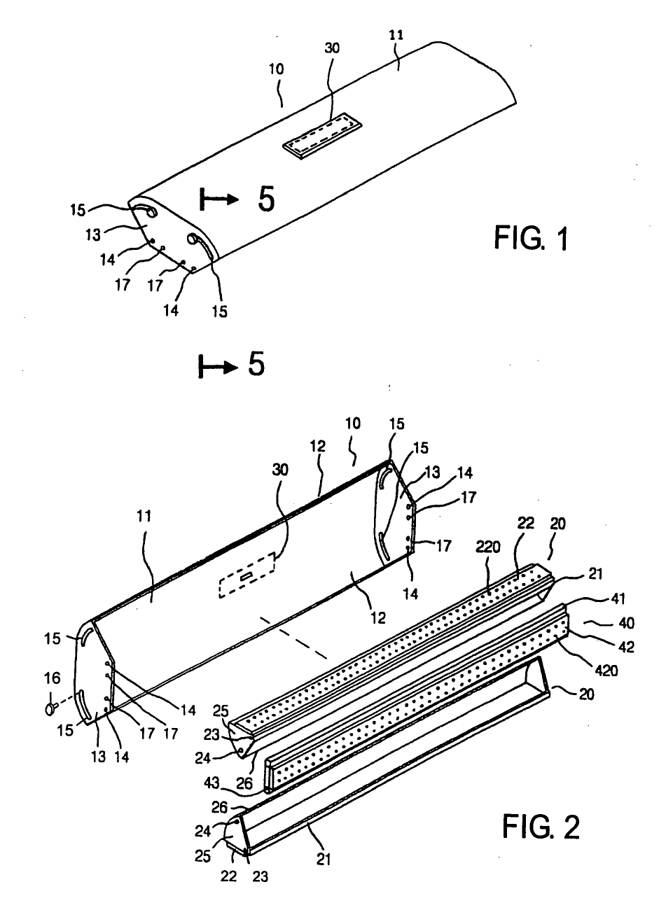

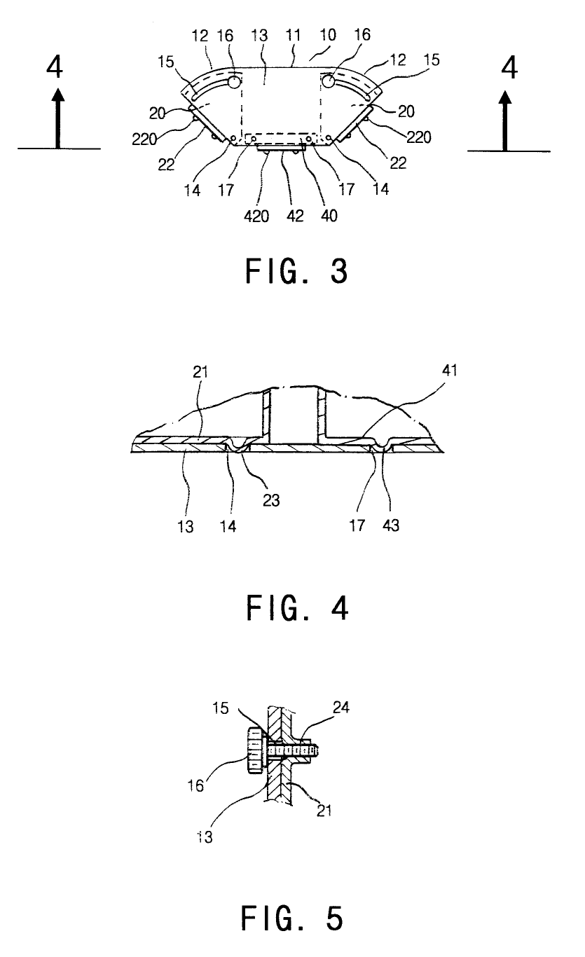

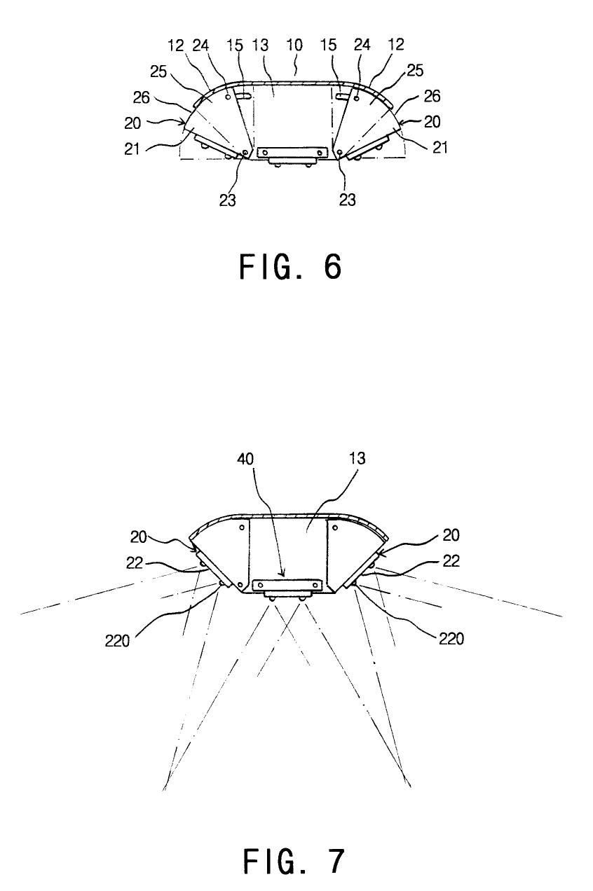

Referring to FIGS. 1 to 9, an LED lighting device in accordance with a preferred embodiment of the invention comprises the following components as discussed in detail below.

A housing 10 is of elongated and is, for example, made of glass. On a portion other than an upper main section 11 of the housing 10, there are provided two pivotal light sources 20 on both inclined sides. The main section 11 has two arc segments 12 on both sides and two end segments 13 of substantially truncated conic shape. Two first holes 14 are provided on both lower corners of the end segment 13. Two arcuate slots 15 are provided proximate both upper corners of the end segment 13. Two spaced second holes 17 are provided between the first holes 14 and the first and second holes 14, 17 are aligned.

The pivotal light source 20 is elongated and has a longitudinal section of triangle. The pivotal light source 20 comprises a base plate 21 on a first elongated surface, a first printed circuit board 22 provided on the base plate 21, an arcuate second elongated surface 26, and two triangular end plates 25. Note that a third elongated surface (not numbered) of the pivotal light source 20 is open. On a first corner of the end plate 25 there is provided a first projecting member 23 pivotably disposed in the first hole 14. On a second corner of the end plate 25 there is provided a threaded hole 24. Each of four screws (e.g., thumb screws) 16 is driven through the slot 15 to secure to the threaded hole 24. As an end, the base plates 21 (i.e., the pivotal light source 20) and the main section 11 of the housing 10 are pivotably secured together. The arcuate second elongated surfaces 26 are pivotably provided on both inclined sides of the main section 11 of the housing 10 so as to conceal the internal components of the housing 10. Size of the shank of the screw 16 is sufficiently less than that of the slot 15. Hence, it is possible of frictionally moving the screw 16 along the slot 15 to pivot the pivotal light source 20 about the first hole 14.

On the first printed circuit board 22 there are provided a plurality of LED members 220 arranged in rows and columns. The LED members 220 are electrically connected to a controller 30 on the main section 11 of the housing 10.

A fixed light source 40 comprises an upper support plate 41 having two spaced second projecting members 43 on either end; and a second printed circuit board 42 mounted under the support plate 41. A plurality of LED members 420 arranged in rows and columns are provided on the second printed circuit board 42 and are electrically connected to the controller 30 on the main section 11 of the housing 10. The second projecting members 43 are fastened in the second holes 17 by snapping so as to secure the fixed light source 40 to the main section 11 of the housing 10.

Note that the fixed light source 40 may be eliminated in other embodiments.

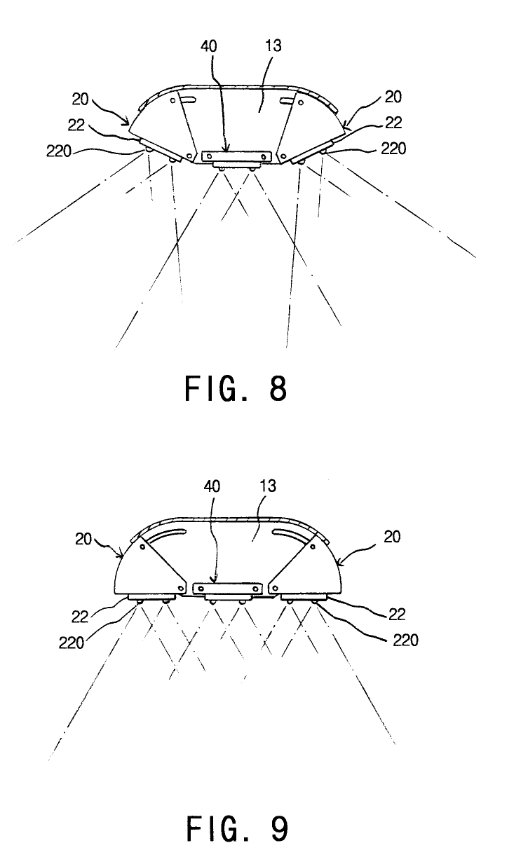

An illumination angle adjustment operation of the invention will be described in detail below. An illumination angle of the LED members 420 is fixed since the fixed light source 40 is affixed to a bottom of the main section 11 of the housing 10 (see FIGS. 7 to 9). A user may counterclockwise pivot the pivotal light sources 20 about the first holes 14 by frictionally moving the screw 16 along the slot 15 from the position shown in FIG. 8 to that shown in FIG. 9. As a result, a narrow angle of illumination is obtained (i.e., illuminating a small area). To the contrary, the user may clockwise pivot the pivotal light sources 20 about the first holes 14 by frictionally moving the screw 16 along the slot 15 from the position shown in FIG. 9 to that shown in FIG. 7 (or FIG. 8). As a result, a wide angle of illumination is obtained (i.e., illuminating a large area).

While the invention herein disclosed has been described by means of specific embodiments, numerous modifications and variations could be made thereto by those skilled in the art without departing from the scope and spirit of the invention set forth in the claims.

What is claimed is:

1. An LED lighting device comprising:
a housing including two inclined open sides and two end segments each having two arcuate side slots proximate a top;
a controller mounted in the housing;
a first light source affixed to a bottom of the housing and comprising a plurality of first LED members mounted thereon, the first LED members being electrically connected to the controller; and
two second light sources each comprising a plurality of second LED members mounted thereon, the second LED members being electrically connected to the controller, two pivots each pivotably secured to a bottom corner of either end segment of the housing, and two sliding members each slidably disposed in the slot,
wherein both the inclined open sides of the housing are concealed by the second light sources, and either second light source is adapted to pivot about the pivots to adjust an angle of illumination of the second LED members by moving the sliding members along the slots.

2. The LED lighting device of claim 1, wherein each of the pivots comprises a projecting member formed on either end of the second light source, and a hole formed on the bottom corner of either end segment of the housing with the projecting member pivotably disposed therein.

3. The LED lighting device of claim 1, wherein each of the second light sources has a longitudinal section of substantially triangular shape.

4. The LED lighting device of claim 1, wherein each of the sliding members is a thumb screw secured to either end of the second light source and slidably disposed in the slot.

5. An LED lighting device comprising:
a housing including two inclined open sides and two end segments each having two arcuate side slots proximate a top;
a controller mounted in the housing; and
two light sources each comprising a plurality of LED members mounted thereon, the LED members being electrically connected to the controller, two pivots each pivotably secured to a bottom corner of either end segment of the housing, and two sliding members each slidably disposed in the slot,
wherein both the inclined open sides of the housing are concealed by the light sources, and either light source is adapted to pivot about the pivots to adjust an angle of illumination of the LED members by moving the sliding members along the slots.

6. The LED lighting device of claim 5, wherein each of the pivots comprises a projecting member formed on either end of the light source, and a hole formed on the bottom corner of either end segment of the housing with the projecting member pivotably disposed therein.

7. The LED lighting device of claim 5, wherein each of the light sources has a longitudinal section of substantially triangular shape.

8. The LED lighting device of claim 5, wherein each of the sliding members is a thumb screw secured to either end of the light source and slidably disposed in the slot.
